(19) United States
(12) Patent Application Publication
(10) Pub. No.: US 2005/0012698 A1
(43) Pub. Date: Jan. 20, 2005

(54) Drive method and drive device of a light emitting display panel

(75) Inventor: Hiroyuki Takahashi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/873,210

(22) Filed: Jun. 23, 2004

(30) Foreign Application Priority Data
Jul. 14, 2003 (JP) 2003-196640

(51) Int. Cl. G09G 3/30

(52) U.S. Cl. 345/77

(57) ABSTRACT

The present invention is to provide a drive device which can prolong the lifetime of light emitting elements constituting a display panel in an environment of a high temperature. A thermistor TH1 is provided in a voltage boosting circuit 4 which drive and light the light emitting elements E11 to Enm in a light emitting display panel 1, and by this thermistor first light emission control means is constituted which drive and light the light emitting elements at an approximately constant light emission intensity value regardless of the level of the environmental temperature. Meanwhile, a current mirror circuit is arranged in an anode line drive circuit 2 which supplies a constant current to the respective light emitting elements E11 to Enm, and second light emission control means in which a current value is controlled by a control voltage Va from a temperature detection means 11A provided with a thermistor TH2 is constructed. The second light emission control means drives and lights the light emitting elements so that the intensity value becomes smaller than the constant light emission intensity value controlled by the first light emission control means in the case where a state in which the environmental temperature exceeds a predetermined value (for example, 50° C.) is detected.

### BACKGROUND OF THE INVENTION

1. Field of the Invention

The present invention relates to a drive device of a light emitting display panel in which for example organic EL (electroluminescent) elements are employed as light emitting elements, and particularly to a drive method and a drive device of a light emitting display panel in which deterioration of light emitting elements constituting a display panel is suppressed so that the light emission lifetime can be prolonged, by regulating the light emission intensity in a high temperature atmosphere.

2. Description of the Related Art

A display panel which is constructed by arranging light emitting elements in a matrix pattern has been developed widely, and as the light emitting element employed in such a display panel, an organic EL element in which an organic material is employed in a light emitting layer has attracted attention. This is because of backgrounds one of which is that by employing, in the light emitting layer of the element, an organic compound which enables an excellent light emitting characteristic to be expected, a high efficiency and a long life which make an EL element satisfactorily practicable have been advanced.

The organic EL element can be electrically shown by an equivalent circuit as shown in FIG. 1. That is, the organic EL element can be replaced by a structure composed of a diode element E and a parasitic capacitance element Cp which is connected in parallel to this diode element, and the organic EL element has been considered as a capacitive light emitting element. When a light emission drive voltage is applied to this organic EL element, at first, electrical charges corresponding to the electric capacity of this element flow into the electrode as a displacement current and are accumulated. It can be considered that when the voltage then exceeds a determined voltage (light emission threshold voltage=Vth) peculiar to the element in question, current begins to flow from the electrode (anode side of the diode element E) to an organic layer constituting the light emitting layer so that the element emits light at an intensity proportional to this current.

FIG. 2 shows light emission static characteristics of such anorganic EL element. According to these, the organic EL element emits light at an intensity L approximately proportional to drive current I as shown in FIG. 2A and emits light while current I flows drastically when the drive voltage V is the light emission threshold voltage Vth or higher as shown in FIG. 2B. In other words, when the drive voltage is the light emission threshold voltage Vth or lower, current rarely flows in the EL element, and the EL element does not emit light. Therefore, the EL element has an intensity characteristic that in a light emission possible region in which the voltage is higher than the threshold voltage Vth, the greater the value of the voltage V applied to the EL element, the higher the light emission intensity L of the EL element as shown by the solid line in FIG. 2C.

It has been known that the intensity property of the organic EL element changes due to changes in environmental temperature roughly as shown by broken lines in FIG. 2C. That is, while the EL element has the characteristic that the greater the value of the voltage V applied thereto, the higher the light emission intensity L thereof in the light emission possible region in which the voltage is higher than the light emission threshold voltage as described above, the EL element also has a characteristic that the higher the temperature becomes, the lower the light emission threshold voltage becomes. Accordingly, the EL element becomes in a state in which light emission of the EL element is possible by a lower applied voltage as the temperature becomes higher, and thus the EL element has a temperature dependency of the intensity that the EL element is brighter at a high temperature time and is darker at a lower temperature time though the same light emission possible voltage is applied.

In general, a constant current drive is performed for the organic EL element due to the reason that the voltage vs. intensity characteristic is unstable with respect to temperature changes as described above while the current vs. intensity characteristic is stable with respect to temperature changes, the reason that the organic EL element is drastically deteriorated by an excess current, and the like. As a display panel employing such organic EL elements, a passive drive type display panel in which the elements are arranged in a matrix pattern has already been put into practical use partly.

In FIG. 3, a conventional passive matrix type display panel and an example of its drive circuit are shown. In drive methods for organic EL elements in the passive matrix drive system, there are two methods that are a cathode line scan/anode line drive and an anode line scan/cathode line drive, and the structure shown in FIG. 3 shows a form of the former cathode line scan/anode line drive. That is, anode lines A1 to An as n data lines are arranged in a vertical direction, cathode lines K1 to Km as m scan lines are arranged in a horizontal direction, and organic EL elements E11 to Enm which are denoted by symbols/marks of diodes are arranged at portions at which respective lines intersect one another (in total, n×m portions) to constitute a display panel 1.

One ends (anode terminals in equivalent diodes of the EL elements) and other ends (cathode terminals in the equivalent diodes of the EL elements) of the respective EL elements E11 to Enm constituting pixels are connected to the anode lines and cathode lines, respectively, corresponding to respective crossing positions between the anode lines A1 to An extending along the vertical direction and the cathode lines K1 to Km extending along the horizontal direction. Further, the respective anode lines A1 to An are connected to an anode line drive circuit 2, and the respective cathode liens K1 to Km are connected to a cathode line scan circuit 3, so as to be driven, respectively.

The anode line drive circuit 2 is provided with constant current sources I1 to In which are operated utilizing a drive voltage VH supplied from a voltage boosting circuit 4 in a later-described DC/DC converter and drive switches Sa1 to San, and the drive switches Sa1 to San are connected to the constant current sources 11 to In sides so that current from the constant current sources I1 to In is supplied to the respective EL elements E11 to Enm arranged corresponding to the cathode lines. The drive switches Sa1 to San are constructed so as to be connected to the ground side provided as a reference potential point when current from the constant current sources I1 to In is not supplied to the respective EL elements.

The cathode line scan circuit 3 is provided with scan switches Sk1 to Skm corresponding to the respective cathode lines K1 to Km and operates so as to allow either a reverse bias voltage VM supplied from a later-described reverse bias voltage generation circuit 5 which is for preventing cross talk light emission or the ground potential as the reference potential point to be connected to corresponding cathode scan lines. Thus, by connecting the constant current sources I1 to In to desired anode lines A1 to An while the cathode lines are set at the scan reference potential point (ground potential) at predetermined cycles, lights of the respective EL elements are selectively emitted.

Meanwhile, the above-mentioned DC/DC converter is constructed so as to generate the drive voltage VH of a direct current while utilizing PWM (pulse width modulation) control as the voltage boosting circuit 4 in the example shown in FIG. 3. For this DC/DC converter, well-known PFM (pulse frequency modulation) control or PSM (pulse skip modulation) control can also be utilized instead of the PWM control.

This DC/DC converter is constructed in such a way that a PWM wave outputted from a switching regulator 6 constituting a part of the voltage boosting circuit 4 controls so that a MOS type power FET Q1 as a switching element is controlled to be turned ON at a predetermined duty cycle. That is, by the ON operation of the power FET Q1, electrical energy from a DC voltage source B1 of a primary side is accumulated in an inductor L1, and the electrical energy accumulated in the inductor L1 is accumulated in a capacitor C1 via a diode D1 accompanied by an OFF operation of the power FET Q1. By repeating of the ON/OFF operation of the power FET Q1, a DC output whose voltage is boosted can be obtained as a terminal voltage of the capacitor C1.

The DC output voltage is divided by a thermistor TH1 performing temperature compensation and resistors R1 and R12, is supplied to an error amplifier 7 in the switching regulator circuit 6, and is compared with a reference voltage Vref in this error amplifier 7. This comparison output (error output) is supplied to a PWM circuit 8, and by controlling the duty cycle of a signal wave produced from an oscillator 9, feedback control is performed so that the output voltage is maintained at a predetermined drive voltage VH. Therefore, the output voltage by the DC/DC converter, that is, the drive voltage VH, can be expressed as follows.
VH=Vref×[(TH1+R11+R12)/R12] [mathematical formula 1]

Meanwhile, the reverse bias voltage generation circuit 5 utilized for preventing the cross talk light emission is constituted by a voltage divider circuit which divides the drive voltage VH. That is, this voltage divider circuit is composed of resistors R13, R14 and an npn transistor Q2 which functions as an emitter follower so that the reverse bias voltage VM is obtained in the emitter of the transistor Q2. Therefore, when the base-emitter voltage in the transistor Q2 is represented as Vbe, the reverse bias voltage VM obtained by the voltage divider circuit can be expressed as follows.
VM=VH×[R14/(R13+R14)]−Vbe [mathematical formula 2]

A control bus extended from a light emission control circuit including an unillustrated CPU is connected to the anode line drive circuit 2 and the cathode line scan circuit 3, and the scan switches Sk1 to Skm and the drive switches Sa1 to San are operated based on a video signal to be displayed. Thus, while the cathode scan lines are set at the ground potential at predetermined cycles based on the video signal, the constant current sources I1 to In are connected to desired anode lines. Accordingly, the light emitting elements selectively emit light, and thus an image based on the video signal is displayed on the display panel 1.

The state shown in FIG. 3 shows that the first cathode line K1 is set at the ground potential to be in a scan state and that at this time the reverse bias voltage VM from the reverse bias voltage generation circuit 5 is applied to the cathode lines K2 to Km in a non-scan state. This works so that respective EL elements connected to the intersection points between the driven anode lines and the cathode lines which have not been selected for scan are prevented from emitting cross talk light.

The passive drive type display panel of the structure shown in FIG. 3 described above and the drive circuit therefor are disclosed in Japanese Patent Application Laid-Open No. 2003-76328 (paragraphs 0007 through 0020 and FIG. 6) shown below that the present applicant has already filed.

Meanwhile, as described above the organic EL element has the characteristic that the higher the temperature in the operational environment becomes, the higher the light emission intensity becomes as the value of the forward voltage VF thereof decreases. For this, as shown in FIG. 3 described above, means for performing temperature compensation by allowing the feedback amount of the converter output to have a temperature characteristic, employing the thermistor TH1, has been adopted. FIGS. 4 and 5 described below show static characteristics of the case where the temperature compensation by the thermistor TH1 is not performed and of the case where the temperature compensation is performed.

First, FIG. 4 shows static characteristics in the case where the thermistor TH1 is not employed in the converter (the case where the temperature compensation is not performed). In FIG. 4A, the horizontal axis represents the environmental temperature Te, and the vertical axis represents the voltage value V, while in FIG. 4B, the horizontal axis represents the environmental temperature Te similarly, and the vertical axis represents the light emission intensity L. As described above, in the case where the temperature compensation is not performed in the converter, as shown in FIG. 4A, the converter output voltage VH and the reverse bias voltage VM become approximately constant voltage values regardless of the level of the environmental temperature Te.

On the other hand, the forward voltage VF of the EL element decreases as the environmental temperature increases. That is, in a state in which the environmental temperature Te is high, the reverse bias voltage VM becomes high with respect to the forward voltage VF of the EL element. Thus, the amount of initial charges during lighting scan time of the EL element becomes large, and as a result, as shown in FIG. 4B, a characteristic is shown in which the light emission intensity L of the EL element increases considerably as the environmental temperature increases.

Meanwhile, FIG. 5 shows static characteristics in the case where the thermistor TH1 is employed in the converter (the case where the temperature compensation is performed). The relationship between the horizontal axis and the vertical axis in FIGS. 5A and 5B is shown by the same relationship as that of the above-described FIGS. 4A and 4B. As described above, in the case where the temperature compensation is performed in the converter, as shown in FIG. 5A, the converter output voltage VH and the reverse bias voltage VM have a characteristic that the voltage values thereof decrease as the environmental temperature Te increases. The forward voltage VF of the EL element decreases as the environmental temperature increases as described above.

Although the EL element has a bare characteristic that the light emission intensity L increases as the temperature increases, since the converter output voltage VH and the reverse bias voltage VM have a characteristic that the voltage values thereof decrease as the environmental temperature Te increases as shown in FIG. 5A, as a result, the light emission intensity L of the EL element shows an approximately constant value regardless of the level of the environmental temperature Te as shown in FIG. 5B. Thus, a basic approach to a drive device of a conventional light emitting display panel is to allow the drive device to have a compensation characteristic by which an approximately flat light emission intensity is obtained regardless of the level of the environmental temperature.

A display panel by self light emitting elements represented by the above-mentioned organic EL elements has a problem that the light emission lifetime thereof becomes shortened in the case where a light emission state is maintained while a predetermined intensity is maintained in a high temperature state (e.g., 50° C. or higher) for example compared to the case where a similar light emission state is continued in an atmosphere of normal temperatures of about 20° C. In the case where the same image continues to be displayed in a high temperature state for a long period of time, it has been acknowledged that a phenomenon, so-called image sticking, is prominently manifested, compared to the case of the above-mentioned normal temperature atmosphere.

Meanwhile, in the case where a display is actually used, a chance that an image of a display panel is visually recognized in an environment that the temperature exceeds for example 50° C. for a long period of time is slim, and a temperature compensation characteristic by which an approximately flat light emission intensity is obtained as described above need not necessarily be provided within the range of all operation guarantee temperatures. That is, in the case where the lifetime of the light emitting element is considered first, to allow the EL element to have a characteristic that the light emission intensity is suppressed in an environment of a predetermined high temperature or higher is one choice, and it can be stated that even when the EL element is allowed to have such a light emission intensity characteristic, inconvenience is not felt so much when it is used actually.

Thus, by excessively operating the temperature compensation characteristic as shown in FIG. 5 in a simple way, output voltage characteristics and a light emission characteristic as shown in FIG. 6 can be obtained. The relationships between the horizontal axes and the vertical axes in FIGS. 6A and 6B are shown by the same relationships between those of FIGS. 5A and 5B. Excessively operating the temperature compensation characteristic as described above is realized for example in the circuit structure of the converter shown in FIG. 3 by changing the resistance ratio of the resistances R11 and R12 connected in series to the thermistor TH1. Thus, as shown in FIG. 6A, the values of the converter output voltage VH and the reverse bias voltage VM can be regulated so as to be decreased further in an environment of a high temperature.

In the case where the above-mentioned regulation is performed, as a result, as shown in FIG. 6B, a temperature compensation characteristic that the light emission intensity L gradually decreases as the environmental temperature Te increases can be obtained. With the light emission intensity characteristic as shown in this FIG. 6B, since the light emission intensity is decreased in an operational environment of a high temperature, a prolongation effect for the lifetime of a light emitting element can be expected even though not quite satisfactorily.

However, in the case of the structure that the temperature compensation characteristics of the converter output voltages are excessively operated as described above, a technical problem described below remains, and problems to be improved exist. One problem thereof is that cross talk light emission of an element increases as the environmental temperature increases since the reverse bias voltage VM decreases considerably as the environment proceeds to an operational region of a high temperature. Another problem is that it becomes difficult to control changes of the intensity in a temperature range used regularly so that the changes are within a predetermined range since the intensity has the characteristic that the intensity simply decreases as the operational temperature increases.

Moreover, in the case of the structure that the temperature compensation characteristics of the converter output voltages are excessively operated as described above, in an environment of a low temperature, since the operational voltage increases largely, not only does the power consumption increase, but also withstand voltage characteristics and withstand current characteristics of the driver have to be improved, whereby problems occur in that increase in cost due to measures taken therefor to cope with the situation is not avoidable and the like.

Accordingly, it is desired that control is performed in such a way that an approximately flat intensity characteristic is provided up to a predetermined temperature range used regularly (e.g., 50° C. or lower) while the light emission intensity is decreased to prolong the lifetime of the element in a state of a high temperature which exceeds the predetermined temperature range. Similarly, in the above-mentioned predetermined temperature range used regularly, it is desired that cross talk light emission can be effectively suppressed.

Although the above is explained based on the temperature compensation operation of the passive drive type display panel shown in FIG. 3, with respect to an active drive type display panel also, it is desired that control is performed in such a way that the light emission lifetime of the element is similarly prolonged particularly in a high temperature state.

### SUMMARY OF THE INVENTION

The present invention has been developed based on the above-described technical viewpoint, and it is an object of the present invention to provide drive methods and drive devices for a light emitting display panel in which control can be performed in such a way that the light emission intensity is maintained in an approximately flat state in a predetermined operational temperature range and that the lifetime of the element is prolonged in the case where the temperature exceeds a predetermined temperature.

A drive method of a light emitting display panel according to the present invention which has been developed in order to carry out the object described above is a drive method of a light emitting display panel in which respective light emitting elements are arranged at respective crossing points between a plurality of data lines and a plurality of scan lines and in which a light emission drive current is selectively supplied to the light emitting elements which become scan objects, characterized mainly by performing light emission control to maintain an approximately constant light emission intensity value regardless of the level of the environmental temperature of the light emitting display panel in a region in which the operational environmental temperature is a predetermined value or lower and by performing light emission control to make a state in which a light emission intensity value is lower than the constant light emission intensity value in a region in which the operational environmental temperature exceeds the predetermined value.

A drive device of a light emitting display panel according to the present invention which has been developed in order to carry out the object described above is a drive device of a light emitting display panel in which respective light emitting elements are arranged at respective crossing points between a plurality of data lines and a plurality of scan lines and which comprises a constant current source which selectively supplies a light emission drive current to the light emitting elements which become scan objects, characterized by comprising first light emission control means which detects the operational environmental temperature of the light emitting display panel to drive and light the light emitting elements at an approximately constant light emission intensity value regardless of the level of the environmental temperature in response to the environmental temperature and second light emission control means which detects the operational environmental temperature of the light emitting display panel to drive and light the light emitting elements so that a light emission intensity value becomes smaller than the constant light emission intensity value in a case where a state in which the environmental temperature exceeds a predetermined value is detected.

Further, a drive device of a light emitting display panel according to the present invention which has been developed in order to carry out the object described above is a drive device of a light emitting display panel provided with a plurality of light emitting elements which are arranged at respective crossing positions between a plurality of data lines and a plurality of scan lines and whose light emission is controlled at least via respective lighting drive transistors, characterized by comprising first light emission control means which detects an operational environmental temperature of the light emitting display panel to drive and light the light emitting elements at an approximately constant light emission intensity value regardless of the level of the environmental temperature in response to the environmental temperature and second light emission control means which detects the operational environmental temperature of the light emitting display panel to drive and light the light emitting elements so that a light emission intensity value becomes smaller than the constant light emission intensity value in a case where a state in which the environmental temperature exceeds a predetermined value is detected.

### BRIEF DESCRIPTION OF THE DRAWINGS

FIG. 1 is an equivalent circuit diagram of an organic EL element;

FIG. 2 is static characteristic graphs showing the characteristics of the organic EL element;

FIG. 3 is a connection diagram showing a drive device of a light emitting display panel in the prior art;

FIG. 4 is characteristic graphs showing an example of the case where temperature compensation is not performed in the converter shown in FIG. 3;

FIG. 5 is characteristic graphs showing an example of the case where temperature compensation is performed in the converter shown in FIG. 3;

FIG. 6 is characteristic graphs showing an example of the case where the temperature compensation of the state shown in FIG. 5 is excessively operated;

FIG. 7 is a connection diagram showing a first embodiment of a drive device according to the present invention;

FIG. 8 is a connection diagram showing a second embodiment similarly;

FIG. 9 is a connection diagram showing a third embodiment similarly;

FIG. 10 is characteristic graphs showing an example of a control voltage generated in a temperature detection means and intensity characteristics of a light emitting element in the embodiments shown in FIGS. 7 to 9;

FIG. 11 is measurement graphs for explaining the light emission lifetime of a green light emitting element provided in the present invention;

FIG. 12 is measurement graphs for explaining the light emission life of a blue light emitting element similarly;

FIG. 13 is a connection diagram showing a fourth embodiment of a drive device according to the present invention;

FIG. 14 is a connection diagram showing a structure which can be appropriately utilized in the embodiment shown in FIG. 13;

FIG. 15 is a connection diagram showing a fifth embodiment of a drive device according to the present invention;

FIG. 16 is a connection diagram showing a sixth embodiment similarly; and

FIG. 17 is a connection diagram showing a seventh embodiment similarly.

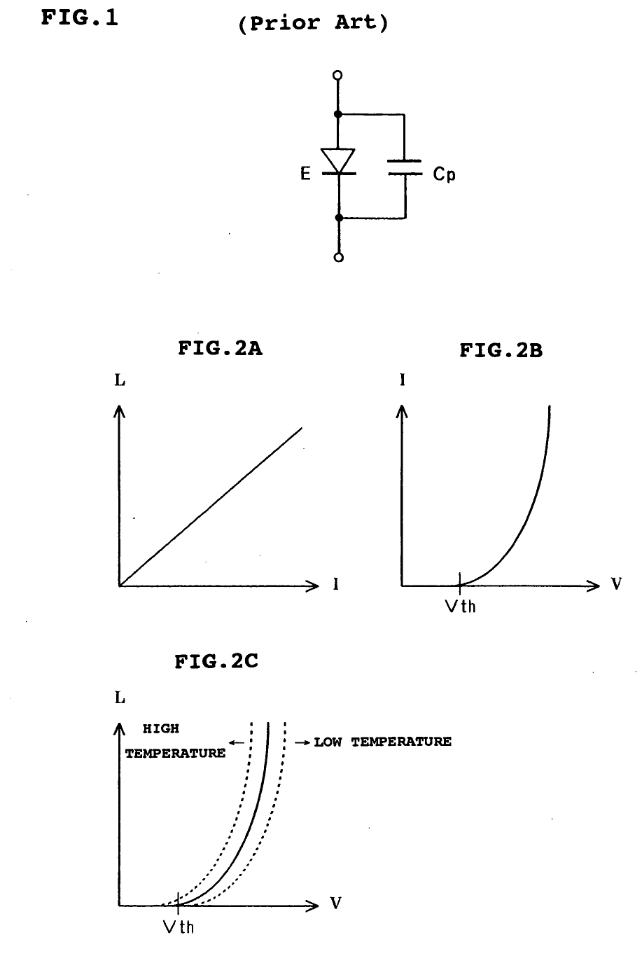

### DESCRIPTION OF THE PREFERRED EMBODIMENTS

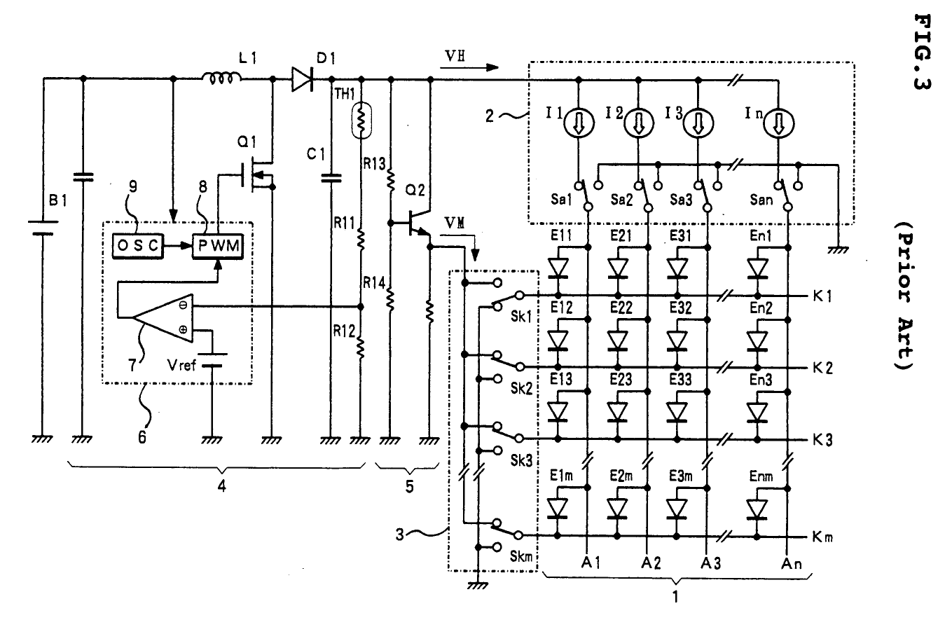

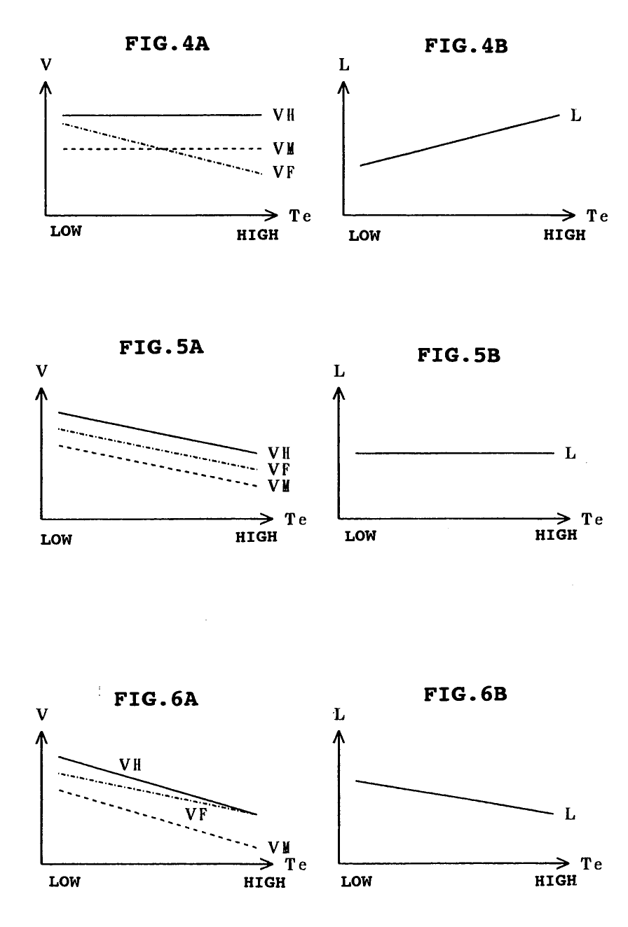

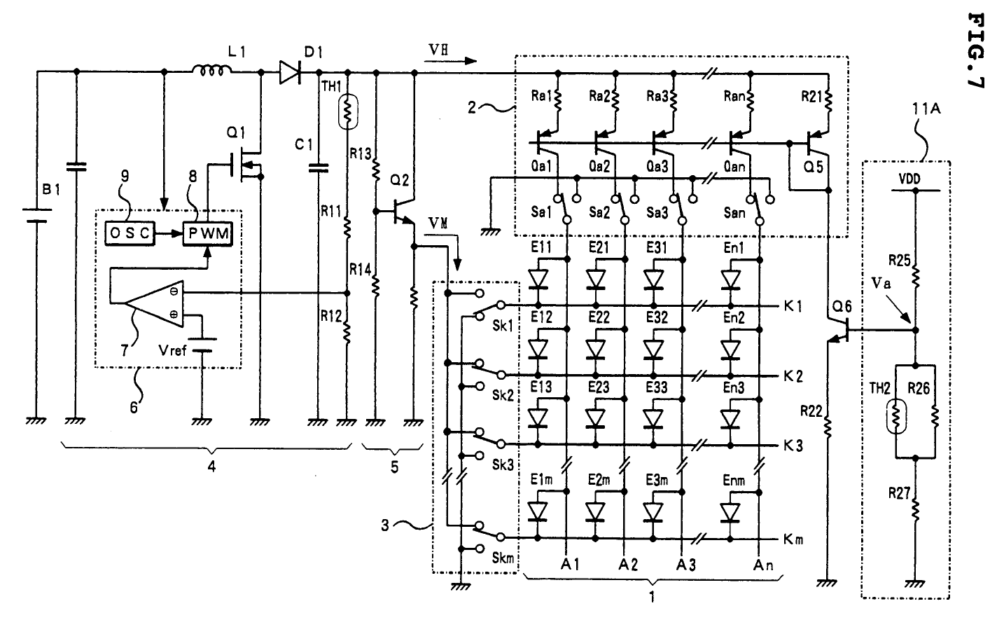

Preferred embodiments of a drive device of a light emitting display panel according to the present invention will be described below with reference to the drawings. FIG. 7 shows a first embodiment thereof and shows an example applied to a drive device of a passive drive type display panel. In FIG. 7, parts corresponding to the respective constituent elements shown in FIG. 3 already described are designated by the same reference characters and numerals, and therefore detailed explanation thereof will be omitted. In the embodiment shown in this FIG. 7, a thermistor TH1 is equipped as described above in a voltage boosting circuit 4 designated by the reference numeral 4 in a DC/DC converter, and by this, temperature compensation is performed as already described above.

The temperature compensation operation of this case is operated in such away that EL elements E11 to Enm as light emitting elements are driven to be lit so as to have an approximately constant light emission intensity value regardless of the level of the environmental temperature, corresponding to an environmental temperature as shown in FIG. 5. We call this first light emission control means for convenience. That is, this first light emission control means operates so as to decrease the levels of the above-described drive voltage VH that is the output voltage of the converter and the reverse bias voltage VM obtained by dividing the drive voltage VH as the environmental temperature increases as described with reference to FIG. 5A. As a result, as shown in FIG. 5B, the EL elements E11 to Enm are driven to be lit at an approximately constant intensity regardless of the level of the environmental temperature.

Meanwhile, in the embodiment shown in FIG. 7, current supply transistors Qa1 to Qan each of which supplies constant current to respective anode lines A1 to An are provided as constant current sources in an anode line drive circuit 2. The respective transistors Qa1 to Qan are constituted by PNP polarity, and the drive voltage VH supplied from the converter is supplied to the emitters thereof via resistance elements Ra1 to Ran, respectively. The collectors of the respective transistors Qa1 to Qan are connected to drive side terminals of the drive switches Sa1 to San.

Further, the bases of the respective transistors Qa1 to Qan are commonly connected to the base of a PNP type control transistor Q5, the drive voltage VH is supplied to the emitter of the control transistor Q5 via a resistance element R21, and the base and the collector of this transistor Q5 are short circuited. That is, the respective transistors Qa1 to Qan and the control transistor Q5 constitute a current mirror circuit. Therefore, in the case where the respective resistance elements Ra1 to Ran and R21 are made equal, current equal to suck current which flows in the collector side of the control transistor Q5 is supplied to the respective anode lines A1 to An.

The collector of an NPN type transistor Q6 is connected to the collector of the control transistor Q5 constituting the current mirror circuit, and the emitter thereof is connected to the ground via a resistance element R22. A control voltage Va from a temperature detection means 11A which detects the environmental temperature is supplied to the base of the transistor Q6. Therefore, by the respective current supply transistors Qa1 to Qan constituting the current mirror circuit, a constant current value supplied to the respective anode lines A1 to An is controlled by the control voltage Va supplied from the temperature detection means 11A.

Meanwhile, in the temperature detection means 11A, a resistance element R25 is connected between an operational power supply VDD and the base of the transistor Q6, a parallel circuit composed of a thermistor TH2 and a resistance element R26 is connected between the base of the transistor Q6 and the ground, and a resistance element R27 is connected in series to this. In the temperature detection circuit 11A of this structure, by employing the negative characteristic thermistor TH2 whose inflection point temperature from a high resistance region to a negative characteristic region is for example 50° C., in an operational environment of 50° C. or higher, an operation that the control voltage Va applied to the base of the current sucking transistor Q6 is decreased can be obtained.

Thus, the current values flowing in the respective current supply transistors Qa1 to Qan which constitute the current mirror circuit receive control in which these current values decrease relatively drastically in the case where the environmental temperature becomes 50° C. or higher. Therefore, the current values supplied to the respective EL elements E11 to Enm which are connected to the respective anode lines to be driven to be lit also receive control in which these current values similarly decrease relatively drastically in the case where the environmental temperature becomes 50° C. or higher, and the light emission intensities thereof also decrease.

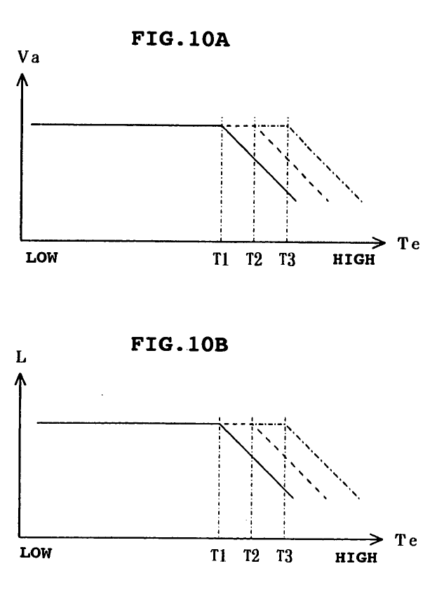

FIG. 10. is for further explaining the above-described operation, wherein FIG. 10A shows one example of a static characteristic of the control voltage Va obtained by the temperature detection means 1A, and FIG. 10B shows an intensity characteristic of the light emitting element based on this result. In FIG. 10A, the horizontal axis represents the environmental temperature Te, and the vertical axis represents the control voltage Va, and in FIG. 10B, the horizontal axis also represents the environmental temperature Te, and the vertical axis represents the light emission intensity L.

First, as shown in FIG. 10A, in a region in which the environmental temperature Te is low, the control voltage Va obtained by the temperature detection means 11A shows an approximately constant value as shown by the solid line, and for example in the case where the environmental temperature becomes 50° C. (T1 shown in the drawing) or higher, the control voltage Va decreases relatively drastically as shown by the solid line. As a result, as shown by the solid line in FIG. 10B, control is performed such that the light emission intensities of the respective EL elements decrease.

Here, the light emission intensity characteristic of the EL element in a region in which the environmental temperature shown in FIG. 10B is T1 or lower utilizes a control aspect shown in FIG. 5 by the first light emission control means already described. The aspect in which control is performed such that the light emission intensity of the EL element is decreased in a region in which the environmental temperature shown in FIG. 10B exceeds T1 is by the structure composed of the temperature detection means 11A and the current mirror circuit. Here, we call the structure composed of the temperature detection means 1A and the current mirror circuit second light emission control means.

In the embodiment shown in FIG. 7, control is performed in such a way that an approximately flat intensity control characteristic is obtained by the first light emission control means over the entire range of the operational environmental temperature Te shown in FIG. 10B and that in the case where the temperature exceeds the predetermined environmental temperature, the second light emission control means operates so that the light emission intensities of the respective EL elements are decreased. Although in the embodiment shown in FIG. 7 an example that the thermistor TH2 whose inflection point temperature from the high resistance region to the negative characteristic region is for example 50° C. is utilized has been described, by utilizing a thermistor whose inflection point temperature is for example 60° C., 70° C., or the like, characteristics shown by the broken line (inflection point temperature T2 is 60° C.) or by the alternate long and short dash line (inflection point temperature T3 is 70° C.) shown in FIG. 10 can be obtained.

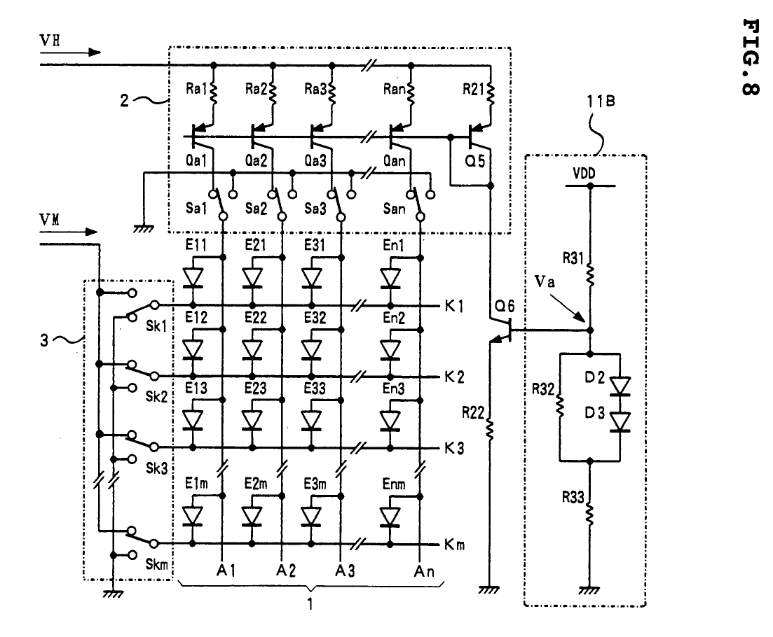

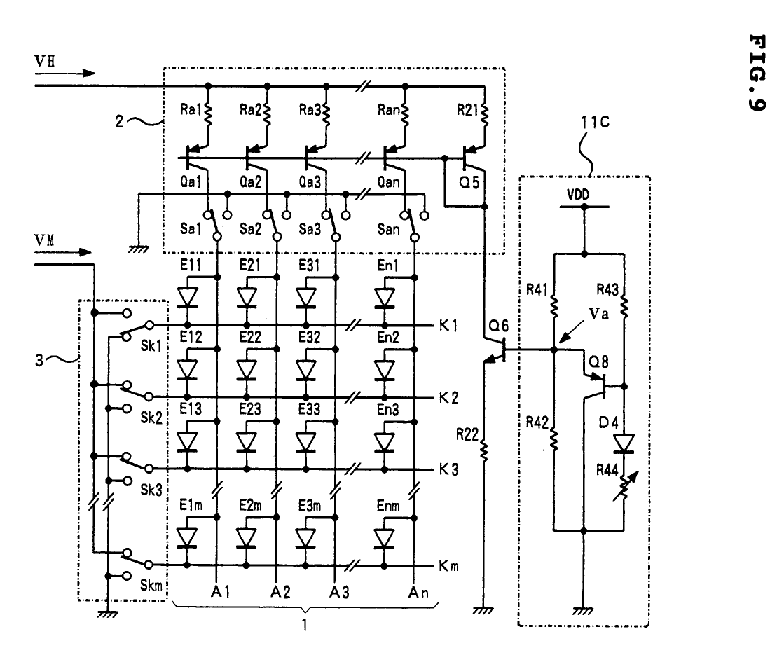

FIG. 8 shows a second embodiment in a drive device of a display panel according to the present invention and shows an example applied similarly to a drive device of a passive drive type display panel. FIG. 8 is shown in such a way that the DC/DC converter section and the reverse bias voltage generation circuit 5 in the embodiment shown in FIG. 7 already described are omitted. In FIG. 8, parts corresponding to the respective constituent elements shown in FIG. 7 are designated by the same reference characters and numerals, and therefore detailed explanation thereof will be omitted.

In the embodiment shown in this FIG. 8, the structure of a temperature detection means 11B is a bit different from the temperature detection means 11A in the structure shown in FIG. 7. In the temperature detection means 11B in the embodiment shown in this FIG. 8, a resistance element R31 is connected between the operational power supply VDD and the base of the transistor Q6, a series connection body of two diodes D2, D3 is connected to the base of the transistor Q6, and a resistance element R32 is connected in parallel thereto. A resistance element R33 is connected in series between the series connection body and the ground.

The temperature detection means 11B shown in FIG. 8 also operates so as to control the level of the control voltage Va, utilizing the temperature dependency of the forward voltages of the two diodes D2, D3. Accordingly, in the structure shown in this FIG. 8 also, control can be performed in such a way that the value of current flowing in the current mirror circuit constituting the second light emission control means decreases relatively drastically when the environmental temperature is a predetermined temperature or higher. As a result, when the environmental temperature is a predetermined temperature or higher, a characteristic shown in FIG. 10 that the light emission intensity of the EL element is decreased can be obtained.

Although the control voltage Va is generated utilizing the temperature dependency of the forward voltages of the diodes D2, D3 in the temperature detection means 11B in the embodiment shown in FIG. 8, for example, an organic EL element as a light emitting element arranged in a light emitting display panel 1 can be utilized instead of these diodes D2, D3. In this case, as an organic EL element employed in the temperature detection means 11B, it is desired that a dummy element which has been formed in advance in the light emitting display panel 1, which does not contribute to light emission, and which is not a scan object is utilized.

In this way, since arranging an organic EL element of a dummy in the display panel 1 hardly influences the panel manufacturing cost and can eliminate necessity of particularly preparing the diodes D2, D3 and the like for the temperature detection, it can contribute to cost reduction of the lighting control circuit.

Next, FIG. 9 shows a third embodiment in a drive device of a display panel according to the present invention and shows an example applied similarly to a drive device of a passive drive type display panel. FIG. 9 is shown in such a way that the DC/DC converter section and the reverse bias voltage generation circuit 5 in the embodiment shown in FIG. 7 already described are omitted. In FIG. 9, parts corresponding to the respective constituent elements shown in FIG. 7 are designated by the same reference characters and numerals, and therefore detailed explanation thereof will be omitted.

In the embodiment shown in this FIG. 9, the structure of a temperature detection means 11C is a bit different from the temperature detection means 11A in the structure shown in FIG. 7. In the temperature detection means 11C in the embodiment shown in this FIG. 9, a resistance element R41 is connected between the operational power supply VDD and the base of the transistor Q6, and a resistance element R42 is connected between the base of the transistor Q6 and the ground.

A series circuit of a resistance element R43, a diode D4, and a variable resistor R44 are connected between the operational power supply VDD and the ground, and the base of a PNP type transistor Q8 is connected to a connection point of the resistance element R43 and the anode in the diode D4. The emitter of the transistor Q8 is connected to a connection point of the resistance element R41 and R42, that is, to the base of the transistor Q6, and the collector of the transistor Q8 is connected to the ground.

The temperature detection means 11C shown in FIG. 9 also operates so as to control the level of the control voltage Va, utilizing the temperature dependency of the diode D4 and the forward voltage between the emitter and the base in the transistor Q8. That is, when the environmental temperature exceeds a predetermined value, the level of the control voltage Va decreases relatively drastically due to negative temperature characteristics of the diode D4 and an equivalent diode between the emitter and base in the transistor Q8.

Therefore, the structure shown in this FIG. 9 also can perform control in such a way that the value of the current flowing in the current mirror circuit constituting the second light emission control means decreases relatively drastically when the environmental temperature is a predetermined temperature or higher. As a result, when the environmental temperature is a predetermined temperature or higher, the characteristic shown in FIG. 10 that the light emission intensity of the EL element decreases can be obtained. With the embodiment shown in FIG. 9, by regulating the variable resistor R44, the operational bias of the transistor Q8 can be regulated, and as a result, inflection point temperatures T1 to T3 changing to negative characteristic regions shown in FIG. 10 can be selectively set.

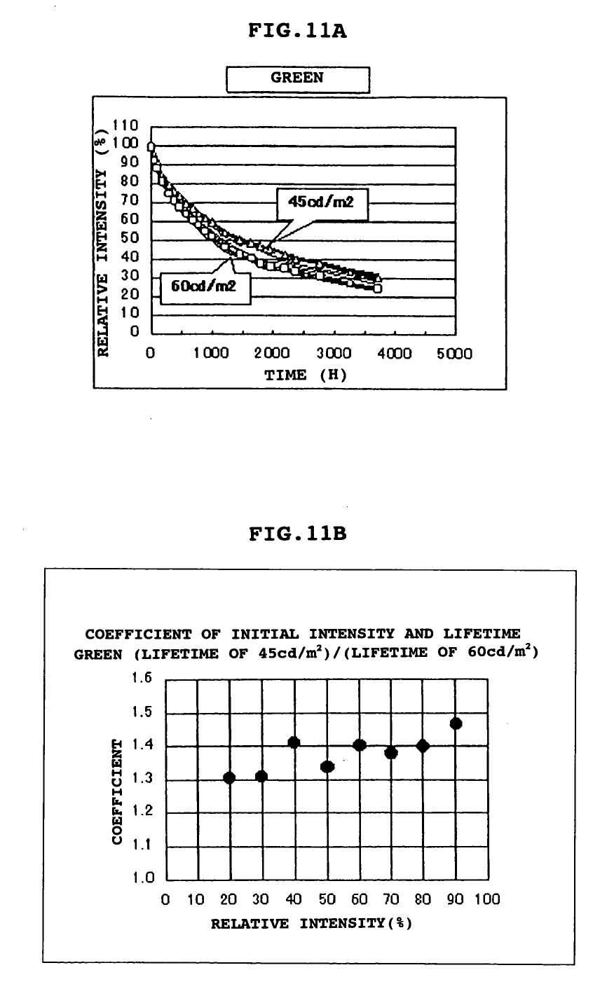

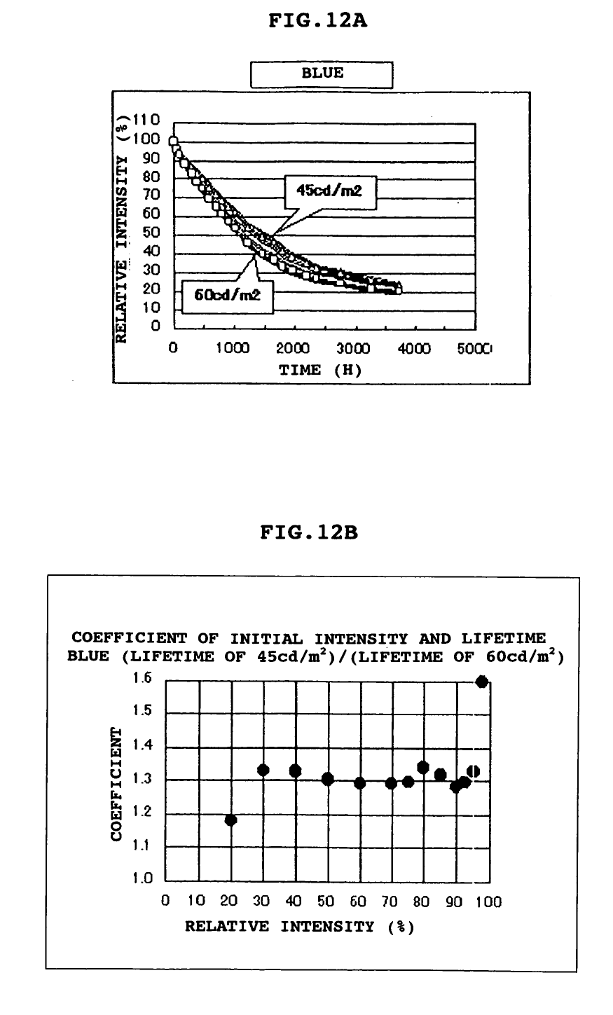

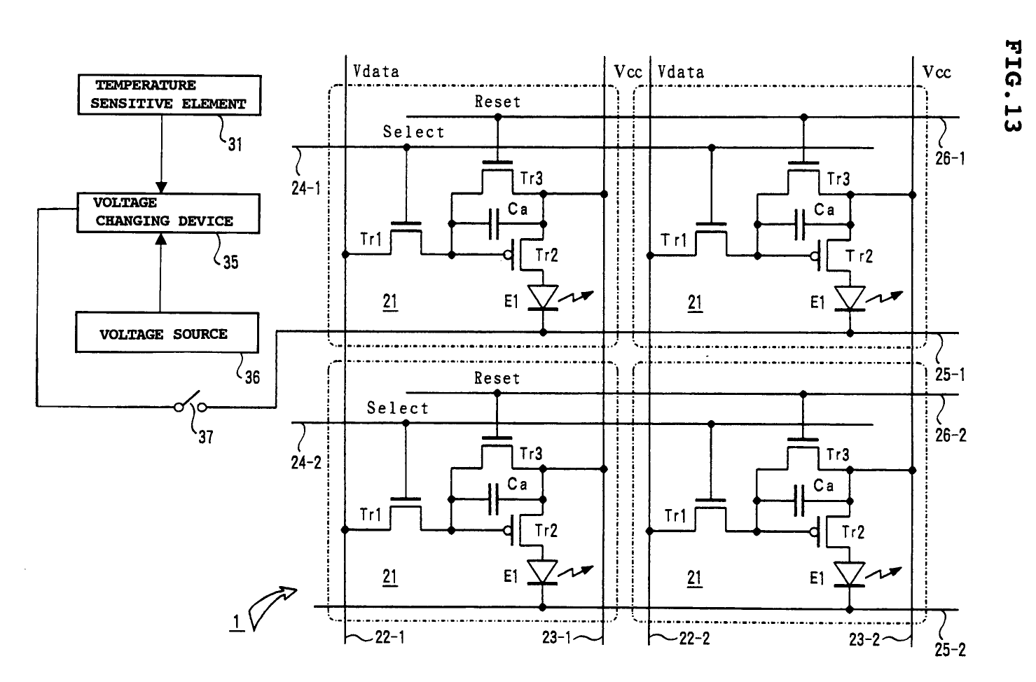

FIGS. 11 and 12 show measurement results for demonstrating that the lifetime of the light emitting element is prolonged in an environment of a relatively high temperature by the light emission intensity control provided with the above-described first light emission control means and the second light emission control means. That is, FIG. 11A shows transitions of the relative intensity of the case where the initial intensity is set at 45 cd/m² and 60 cd/m² in an environment of 65° C. in a display panel in which organic EL elements of green light emission are arranged such that lighting is continuously performed, wherein the horizontal axis represents elapsed time and the vertical axis represents the relative intensity.

In FIG. 11B the horizontal axis represents the relative intensity shown in FIG. 11A, and FIG. 11B shows coefficients of the light emitting time of the case where the initial intensity is 45 cd/m² and of the light emitting time of the case where initial intensity is 60 cd/m², corresponding to the relative intensity. FIGS. 12A and 12B show measurement results in a display panel in which organic EL elements of blue light emission are arranged under the same conditions as those shown in FIGS. 11A and 11B.

FIG. 11A and FIG. 12A show that when the light emission intensity is decreased (when the initial intensity is set at 45 cd/m²) in the case where the environmental temperature is high (65° C.), decrease of the relative intensity with respective to the initial intensity is reduced. In other words, it can be understood that the light emission lifetime is prolonged. With FIG. 11B and FIG. 12B, it can be understood that a prolongation effect of the light emission lifetime of approximately 1.3 to 1.5 times can be obtained in a display panel in which organic EL elements of green light emission are arranged when control that the light emission intensity is decreased from 60 cd/m² to 45 cd/m² is performed in the case where the environmental temperature is high (65° C.). It can be understood that a prolongation effect of the light emission lifetime of approximately 1.2 to 1.6 times can be obtained in a display panel in which organic EL elements of blue light emission are arranged.

Next, FIG. 13 shows a fourth embodiment in a drive device according to the present invention and shows an example applied to a drive device of a passive drive type display panel. This embodiment shows an example in which a lighting drive system which is called a simultaneous erasing scan (SES) method that realizes time division gradation expression is adopted.

In a display panel 1 in this embodiment, a plurality of data electrode lines 22-1, 22-2, . . . to each of which a data signal Vdata corresponding to a video signal supplied from an unillustrated data driver is supplied are arranged in a column direction, and power supply lines 23-1, 23-2, . . . to which a drive power supply Vcc is supplied in parallel to the data electrode lines are also arranged. A large number of scan electrode lines 24-1, 24-2, . . . to which a scan signal Select supplied from an unillustrated scan driver is supplied are arranged in a row direction, and a large number of power supply control lines 25-1, 25-2, . . . are also arranged in parallel to the scan electrode lines. Further, a large number of erase signal lines 26-1, 26-2, . . . to each of which an erase signal Reset supplied from an unillustrated erase driver is supplied are also arranged in the row direction.

Respective control TFT (thin film transistor), drive TFT, capacitor, and erase TFT are equipped in each pixel 21 which includes an EL element E1 as a light emitting element. In the form shown in FIG. 13, the scan signal Select from the unillustrated scan driver is imparted to the gates of first transistors Tr1 (hereinafter referred to also as control transistors) via the scan electrode lines 24-1, 24-2, . . . . The sources of the control transistors Tr1 are connected to the data electrode lines 22-1, 22-2, . . . , and the drains thereof are connected to the gates of second transistors Tr2 (hereinafter referred to also as drive transistors) provided as drive TFTs as well as to one ends of capacitors Ca.

The other ends of the capacitors Ca and the sources of the drive transistor Tr2 are connected to the power supply lines 23-1, 23-2, . . . , and the drains of the drive transistors Tr2 are connected to the anode terminals of the respective EL elements E1. The cathode terminals of the respective EL elements E1 are connected to the respective power supply control lines 25-1, 25-2, . . . . An erase signal Reset from the unillustrated erase driver is given to the gates of third transistors Tr3 (hereinafter referred to also as erase transistors) provided as erase TFTs via the erase signal lines 26-1, 26-2, . . . . The sources and drains of the erase transistors Tr3 are connected to end portions of the capacitors Ca, respectively. In each pixel 21 shown in FIG. 13, only the drive transistor Tr2 is constituted by a P-channel type TFT, and other transistors are constituted by N-channel type TFTs.

Although four pixels 21 are drawn for convenience of space in the example shown in FIG. 13, a plurality of such pixels 21 are arranged in a matrix pattern in the row and column directions to constitute a display panel 1. An ON voltage is supplied one after another from the unillustrated scan driver to the gates of the control transistors Tr1 constituting the respective pixels 21 during an address period. Thus, current corresponding to the data signal Vdata is allowed to flow in the capacitor Ca via the source and drain of the control transistor Tr1, whereby the capacitor Ca is charged. Such a charge voltage is supplied to the gate of the drive transistor Tr2, and the transistor Tr2 allows current corresponding to the gate voltage thereof and the drive power supply Vcc supplied to the power supply lines 23-1, 23-2, . . . to flow in the EL element E1, whereby the EL element E1 emits light.

When the gate voltage of the control transistor Tr1 becomes an OFF voltage, the transistor Tr1 becomes a so-called cutoff. However, since the gate voltage of the drive transistor Tr2 is maintained by electrical charges accumulated in the capacitor Ca, drive current to the EL element E1 is maintained. Accordingly, the EL element E1 can continue a lighting state corresponding to the data signal Vdata during a period which reaches a next scan (e.g., one frame period).

Meanwhile, in this embodiment, control is performed so that the erase signal Reset which turns the erase transistor Tr3 on is supplied from the unillustrated erase driver in the middle of the lighting period of the EL element E1 (e.g., in the middle of one frame period). Thus, electrical charges charged in the capacitor Ca can be erased (discharged) instantaneously. As a result, the drive transistor Tr2 becomes a cutoff state, and the EL element E1 is turned off immediately. In other words, by controlling output timing of a gate ON voltage from the unillustrated erase driver, the lighting period of the EL element E1 is controlled, whereby multi-gradation can be realized.

In a power supply circuit for allowing the display panel 1 provided with the respective pixels 21 to be driven to be lit also, the DC/DC converter having a temperature compensation characteristic which functions as the first light emission control means as shown in FIG. 7 already described can be suitably utilized. Since the display panel 1 shown in FIG. 13 is an active drive type, a generation circuit of the above-mentioned reverse bias voltage VM becomes unnecessary. In the embodiment shown in FIG. 13 also, in the case where the environmental temperature exceeds a predetermined temperature, the second light emission control means operates so that control is performed such that the light emission intensities of the respective EL elements are decreased.

That is, the second light emission control means in this FIG. 13 is composed of a temperature sensitive element 31, a voltage source 36, and a voltage changing device 35 and is constructed in such a way that an output terminal of the voltage changing device 35 is connected to the respective power supply control lines 25-1, 25-2, . . . via a switch 37. FIG. 13 shows a state in which the output terminal of the voltage changing device 35 is connected to the first power supply control line 25-1 via the switch 37.

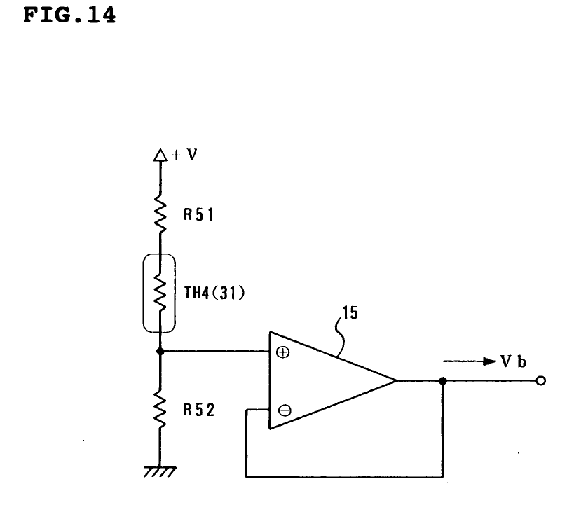

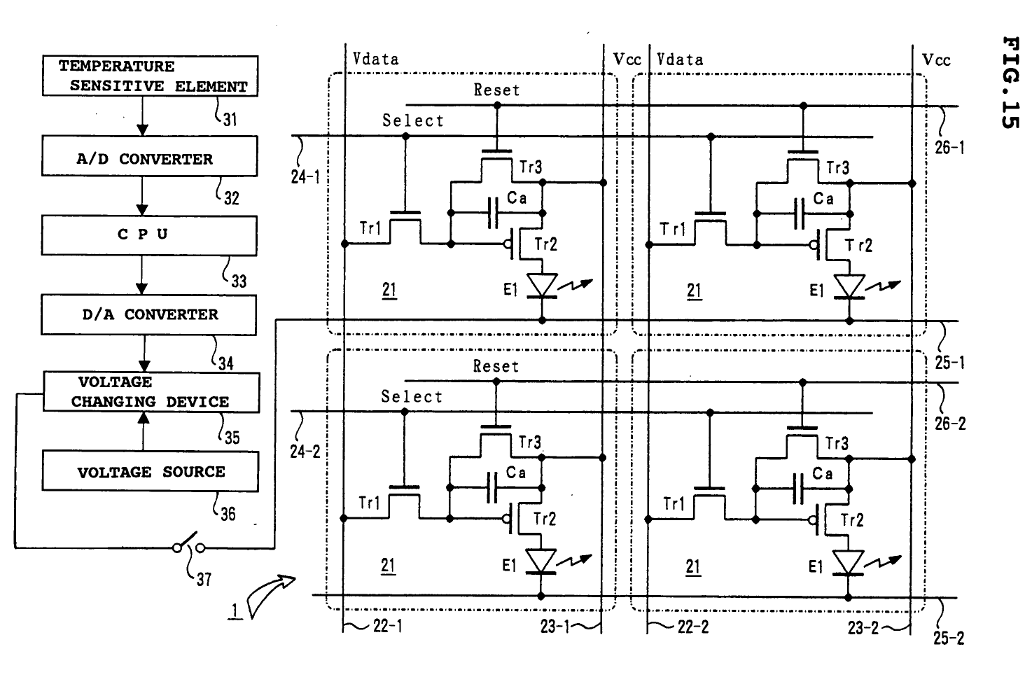

Here, the structure of the temperature sensitive element 31, the voltage changing device 35, the voltage source 36 constituting the second light emission control means can be replaced for example with a circuit structure shown in FIG. 14. That is, respective resistors R51 and R52 are connected in series to both ends of a thermistor TH4 provided as a temperature sensitive element 31 so that a voltage source +V is applied to this series connection body. The non-inverting input terminal of an operational amplifier 15 is connected to a connection point between the thermistor TH4 and the resistor R52. The output terminal of the operational amplifier 15 is connected (returned) to the inverting input terminal to function as a buffer amplifier, and thus an output voltage Vb based on the electrical potential at the connection point between the thermistor TH4 and the resistor R52 is outputted to the operational amplifier 15.

In the structure shown in FIG. 14, in the case where the negative characteristic thermistor TH4 whose inflection point temperature from a high resistance region to a negative characteristic region is for example 50° C. is employed, in an operational environment of 50° C. or higher, an operation that the level of the output voltage Vb in the operational amplifier 15 is drastically increased can be obtained. Accordingly, by supplying the output of the operational amplifier 15 to the power supply control line 25-1 of the display panel 1 shown in FIG. 13, the drive voltage value applied to the EL elements E1 provided as light emitting elements can be controlled to be changed. Therefore, in the case of an operational environment of 50° C. or higher, the electrical potentials of the cathode sides of the respective EL elements E1 increase, and the light emission intensities of the EL elements E1 are decreased.

By the above-described operation, in the embodiment shown in FIG. 13 also, an intensity characteristic corresponding to the environmental temperature described with reference to FIG. 10 can be obtained, and as a result, a prolongation effect of the light emission lifetime of an EL element as described with reference to FIGS. 11 and 12 can be expected.

FIG. 15 shows a fifth embodiment in a drive device according to the present invention, and this also shows an example applied to a drive device of an active drive type display panel. In FIG. 15, parts corresponding to the respective constituent elements shown in FIG. 13 already described are designated by the same reference characters and numerals, and therefore detailed explanation thereof will be omitted. In the structure shown in this FIG. 15, an A/D converter 32, a CPU 33 working as an operation control function, and a D/A converter 34 are added to the structure shown in FIG. 13.

That is, an analog signal which is dependent on the environmental temperature and which is outputted from a temperature sensitive element represented by the thermistor TH4 is converted to digital data by the A/D converter 32 and is incorporated in the CPU 33. Processes necessary in the CPU 33 and the like are executed for the obtained digital signal, and the digital signal is converted into an analog signal again by the D/A converter 34. The analog signal by the D/A converter 34 is supplied to the voltage changing device 35, and the voltage changing device 35 operates so as to control the level of the output voltage in accordance with the analog signal corresponding to the environmental temperature.

The output by the voltage changing device 35 is supplied to the power supply control lines 25-1, 25-2, . . . arranged in the display panel 1, similarly to the example shown in FIG. 13, to operate so as to shift the electrical potentials of the power supply control lines 25-1, 25-2, . . . in response to the environmental temperature. Therefore, the embodiment shown in this FIG. 15 also, interactions and effects similar to those of the embodiment shown in FIG. 13 can be obtained.

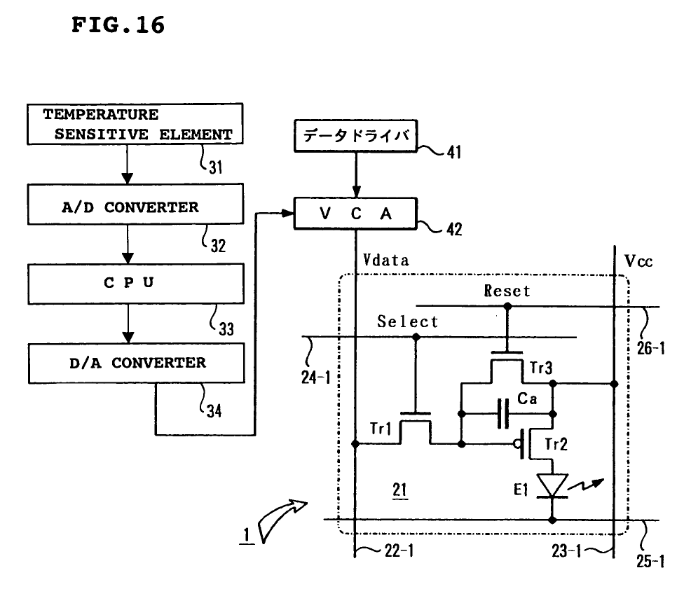

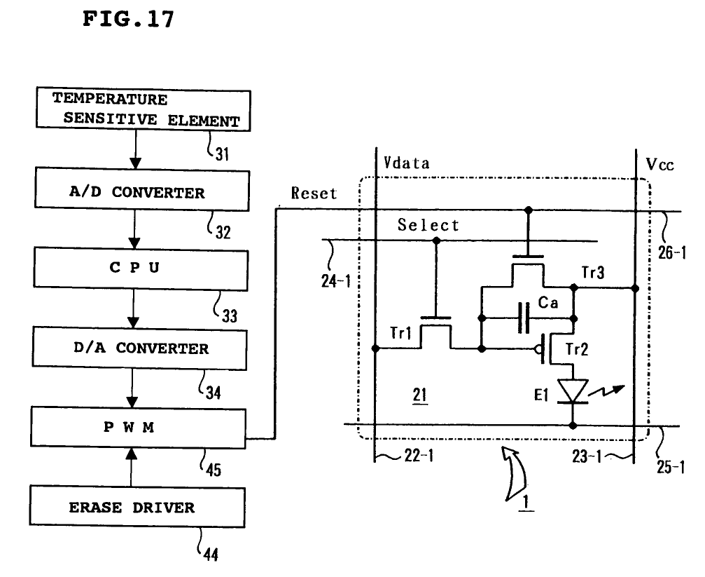

FIG. 16 shows a sixth embodiment in a drive device according to the present invention, and this also shows an example applied to a drive device of an active drive type display panel. In FIG. 16, parts corresponding to the respective constituent elements shown in FIGS. 13 and 15 already described are designated by the same reference characters and numerals, and therefore detailed explanation thereof will be omitted. In FIG. 16, only one pixel 21 is drawn representatively in the display panel 1.

In the embodiment shown in this FIG. 16, the level of the data signal Vdata supplied to the data electrode lines 22-1, 22-2, . . . is controlled by an analog signal which is dependent on the environmental temperature and which is outputted from the D/A converter 34, and as a result, the value of drive current supplied to the EL element E1 via the drive transistor Tr2 is controlled to be changed. That is, the analog signal which is dependent on the environmental temperature and which is outputted from the D/A converter 34 is supplied to a VCA (voltage control amplifier) 42 as a control signal. A data signal corresponding to video data is supplied as the controlled signal to the VCA 42 by a data driver 41. Thus, the data signal receives level control by the analog signal which is dependent on the environmental temperature and which is outputted from the D/A converter 34 and is supplied to the data electrode lines 22-1, 22-2, . . . as the data signal Vdata.

The above-described structure is constructed in such a way that the gain of the VCA 42 is decreased by the control signal supplied from the D/A converter 34 in the case where the environmental temperature becomes for example 50° C. or higher. Thus, the charge voltage for the capacitor Ca constituting the pixel 21 decreases, and in accordance with this, the value of the drive current supplied to the EL element E1 by the drive transistor Tr2 also decreases. Accordingly, in the case where the environmental temperature becomes for example 50° C. or higher, the light emission intensity of the EL element E1 decreases.

With this operation, in the embodiment shown in FIG. 16 also, an intensity characteristic corresponding to the environmental temperature described with reference to FIG. 10 can be obtained, and as a result, a prolongation effect of the light emission lifetime of the EL element as described with reference to FIGS. 11 and 12 can be expected.

FIG. 17 shows a seventh embodiment in a drive device according to the present invention, and this also shows an example applied to a drive device of an active drive type display panel. In FIG. 17, parts corresponding to the respective constituent elements shown in FIGS. 13, 15, and 16 already described are designated by the same reference characters and numerals, and therefore detailed explanation thereof will be omitted. In FIG. 17 also, only one pixel 21 is drawn representatively in the display panel 1.

In the embodiment shown in this FIG. 17, the period for allowing the EL element E1 to be lit is controlled to be changed via the lighting drive transistor Tr2 by the analog signal which is dependent on the environmental temperature and which is outputted from the D/A converter 34 is supplied as the control signal to a PWM (pulse width modulator) 45. An erase signal from an erase driver 44 is supplied to the PWM 45 so that sending timing of the erase signal Reset supplied to the erase signal lines 26-1, 26-2, . . . is regulated.

As one means for realizing the above-described operation, the PWM 45 is constructed such that in a reference chopping wave and a reference voltage supplied to an unillustrated comparator, the level of the reference voltage is changed by the analog signal outputted from the D/A converter 34. Thus, control is performed wherein arrival timing of a crossing point between the reference chopping wave and the reference voltage is changed by the environmental temperature.

That is, in the case where the environmental temperature becomes for example 50° C. or higher, the PWM 45 operates so that the arrival timing of the crossing point between the reference chopping wave and the reference voltage is advanced. Accordingly, in the case where the environmental temperature becomes for example 50° C. or higher, generation timing of the erase signal Reset supplied to the erase signal lines 26-1, 26-2, . . . is advanced for example in each lighting period of one frame.

Therefore, for example in each lighting period of one frame, timing that the erase transistor Tr3 is turned on is advanced, and the period in which the EL element E1 is driven to be lit via the drive transistor Tr2 is shortened. Thus, control is performed such that the light emission intensity of the EL element E1 decreases.

With this operation, in the embodiment shown in FIG. 17 also, an intensity characteristic corresponding to the environmental temperature described with reference to FIG. 10 can be obtained, and as a result, a prolongation effect of the light emission lifetime of the EL element as described with reference to FIGS. 11 and 12 can be expected.

A drive device of an active drive type display panel described above can employ means for controlling and changing the value of the drive voltage added to the EL element shown in FIGS. 13 and 15, means for controlling and changing the value of the drive current supplied to the EL element via the drive transistor shown in FIG. 16, and means for controlling and changing the period in which the EL element is lit via the drive transistor shown in FIG. 17 together.

1. A drive method of a light emitting display panel in which respective light emitting elements are arranged at respective crossing points between a plurality of data lines and a plurality of scan lines and in which a light emission drive current is selectively supplied to the light emitting elements which become scan objects, the drive method of the light emitting display panel characterized by performing light emission control to maintain an approximately constant light emission intensity value regardless of the level of the environmental temperature of the light emitting display panel in a region in which the operational environmental temperature is a predetermined value or lower and by performing light emission control to make a state in which a light emission intensity value is lower than the constant light emission intensity value in a region in which the operational environmental temperature exceeds the predetermined value.

2. The drive method of the light emitting display panel according to claim 1, characterized in that light emission control for the light emitting elements is performed by first light emission control means which maintains an approximately constant light emission intensity value regardless of the level of the environmental temperature in response to the operational environmental temperature and that second light emission control means which controls the light emission intensity of the light emitting elements in such a way that the light emission intensity means which controls the light emission intensity of the light emitting elements in such a way that the light emission intensity becomes an intensity value which is lower than the constant light emission intensity value operates in a region in which the operational environmental temperature exceeds the predetermined value.

3. A drive device of a light emitting display panel in which respective light emitting elements are arranged at respective crossing points between a plurality of data lines and a plurality of scan lines and which comprises a constant current source which selectively supplies a light emission drive current to the light emitting elements which become scan objects, the drive device of the light emitting display panel characterized by comprising first light emission control means which detects the operational environmental temperature of the light emitting display panel to drive and light the light emitting elements at an approximately constant light emission intensity value regardless of the level of the environmental temperature in response to the environmental temperature and second light emission control means which detects the operational environmental temperature of the light emitting display panel to drive and light the light emitting elements so that a light emission intensity value becomes smaller than the constant light emission intensity value in a case where a state in which the environmental temperature exceeds a predetermined value is detected.

4. The drive device of the light emitting display panel according to claim 3, characterized in that the first light emission control means is constructed so as to control and change the value of a drive voltage which operates the constant current source in response to the environmental temperature and the value of a reverse bias voltage applied to the light emitting elements which are non-scan objects.

5. The drive device of the light emitting display panel according to claims 3 or 4, characterized in that the second light emission control means performs control in such a way that the value of the current of the constant current source is decreased in a state in which the environmental temperature exceeds a predetermined value.

6. The drive device of the light emitting display panel according to claim 5, characterized in that the second light emission control means constitutes a current mirror circuit by respective current supply transistors which supply constant current to respective data lines and by a control transistor which controls the value of the current flowing in the respective current supply transistors, corresponding to the environmental temperature.

7. A drive device of a light emitting display panel provided with a plurality of light emitting elements which are arranged at respective crossing positions between a plurality of data lines and a plurality of scan lines and whose light emission is controlled at least via respective lighting drive transistors, the drive device of the light emitting display panel characterized by comprising first light emission control means which detects an operational environmental temperature of the light emitting display panel to drive and light the light emitting elements at an approximately constant light emission intensity value regardless of the level of the environmental temperature in response to the environmental temperature and second light emission control means which detects the operational environmental temperature of the light emitting display panel to drive and light the light emitting elements so that a light emission intensity value becomes smaller than the constant light emission intensity value in a case where a state in which the environmental temperature exceeds a predetermined value is detected.

8. The drive device of the light emitting display panel according to claim 7, characterized in that the second light emission control means controls and changes the value of a drive voltage added to the light emission element.

9. The drive device of the light emitting display panel according to claim 7, characterized in that the second light emission control means controls and changes the value of a drive current supplied to the light emission elements via the lighting drive transistors.

10. The drive device of the light emitting display panel according to claim 7, characterized in that the second light emission control means controls and changes a period in which the light emission elements are lit via the lighting drive transistors.

11. The drive device of the light emitting display panel according to claim 7, characterized in that the second light emission control means is constructed so as to employ any two or more means of the means controlling and changing the value of the drive voltage added to the light emitting elements, the means controlling and changing the value of the drive current supplied to the light emitting elements via the lighting drive transistors, and the means controlling and changing the period in which the light emitting elements are lit via the lighting drive transistors.

12. The drive device of the light emitting display panel according to claims 3 or 4, characterized in that a thermistor is employed for a temperature detection means detecting the operational environmental temperature.

13. The drive device of the light emitting display panel according to any one of claims 7 to 11, characterized in that a thermistor is employed for a temperature detection means detecting the operational environmental temperature.

14. The drive device of the light emitting display panel according to claims 3 or 4, characterized in that a diode element is employed for a temperature detection means detecting the operational environmental temperature.

15. The drive device of the light emitting display panel according to any one of claims 7 to 11, characterized in that a diode element is employed for a temperature detection means detecting the operational environmental temperature.

16. The drive device of the light emitting display panel according to claims 3 or 4, characterized in that the light emitting element arranged in the light emitting display panel is employed for a temperature detection means detecting the operational environmental temperature.

17. The drive device of the light emitting display panel according to any one of claims 7 to 11, characterized in that the light emitting element arranged in the light emitting display panel is employed for a temperature detection means detecting the operational environmental temperature.

18. The drive device of the light emitting display panel according to claims 3 or 4, characterized in that the light emitting element constituting the light emitting display panel is an organic EL element.

19. The drive device of the light emitting display panel according to any one of claims 7 to 11, characterized in that the light emitting element constituting the light emitting display panel is an organic EL element.
